(19) United States
(12) Patent Application Publication
(10) Pub. No.: US 2010/0002554 A1
(43) Pub. Date: Jan. 7, 2010

(54) OPTICAL DISK DEVICE AND OPTICAL DISK TYPE DETERMINATION METHOD

(76) Inventors: Masaki Nakano, Tokyo (JP); Masatsugu Ogawa, Tokyo (JP); Shuichi Ohkubo, Tokyo (JP)

Correspondence Address: Mr. Jackson Chen, 6535 N. STATE HWY 161, IRVING, TX, 75039, US

(21) Appl. No.: 12/518,150

(22) PCT Filed: Dec. 5, 2007
(86) PCT No.: PCT/JP2007/073516

§ 371 Date: Jul. 10, 2009

(30) Foreign Application Priority Data
Dec. 7, 2006 (JP) 2006-330573

(51) Int. Cl. G11B 7/00

(52) U.S. Cl. 369/53.2; G9B/7

(57) ABSTRACT

An optical disk device includes an optical head unit, a drive means and a recording surface state determination means, and determines the type of an optical disk based on a state of the information recording surface. The information recording surface includes a management region on which management information is recorded and formed by a guiding groove or a prepit sequence and a data recording region on which a user data is recorded and on which a track formed by a guiding groove or a prepit sequence. The optical head unit irradiates a focused beam onto the information recording surface of an optical disk which rotates. The drive means drives to move the focused beam along a radial direction of the optical disk by driving the optical head unit. The recording surface state determination means determines a state of the information recording surface based on a reflected light of the focused beam. The optical disk device determines the type of the optical disk based on a state of the information recording surface in a determination region being set to straddle between a management region and the data recording region.

### TECHNICAL FIELD

The present invention relates to an optical disk device which is able to reproduce and/or record to plural types of optical disks, and to a determination method of the types of an optical disk.

### BACKGROUND ART

The amount of processing data is increasing in accordance with diversification of information and the other situations, also in the field of storage. Also in the optical disk, efforts to enlarge the capacity based on the increase of the density have been made such as from the CD (Compact Disk) to the DVD (Digital Versatile Disk. Further, a next-generation optical disk (for example, so-called HD DVD) is now being introduced to the market. in these optical disks, their outer shapes are identical, but their storage capacities are different. The difference of the capacity is achieved by changing a format, for example, the size of a formed pit (a formed mark) and the width of a groove (the track pitch).

For the respective. optical disks having different capacities, wavelengths of the laser beam used for information reading and recording are also different from each other, for example, lasers of: near 780 nm wavelength in the CD; near 650 nm wavelength in the DVD; and near 405 nm wavelength in the HD DVD are used. As described above, though their outer shapes are identical, there are substantially plural types of the optical disks. A plurality of optical disk devices dedicated to each type of the optical disks individually exists. However, optical disk devices which are able to carry out the reproduction and recording of plural types of the optical disks each having a different capacity have also been introduced. Under such situation, methods and apparatuses for determining the optical disk which will be described below are known.

For example, in Japanese Laid-Open Patent Application JP-A-Heisei, 9-320179, a technique about the determination of the CD and the DVD is disclosed. In this determination method, an objective lens for introducing the laser light emitted by a laser light source to an optical disk with focusing the light is moved to the optical axis direction, and the determination is carried out based on the generation timing and the amplitude of the predetermined S-shaped waveform indicated in the focus error signal generated from the laser light reflected at the optical disk in the movement of the objective lens along the optical axis direction. This is a determination method using the difference between the CD and the DVD in the substrate thickness to the recording surface where information is recorded (the difference in the distance between the disk surface and the recording surface). However, in a next-generation optical disk, especially the HD DVD that is a next-generation optical disk having a similar structure to the DVD, the substrate thickness is same, and thus such method using the difference of the substrate thickness cannot carry out fast and accurate identification.

In addition, a determination method of optical disks including a next-generation optical disk is disclosed in Japanese Laid-Open Patent Application JP-P2004-152452A. According to this document, in an optical head having three PDs (Photo Detectors) for the CD, the DVD, and the next-generation optical disk (HD DVD), the type of an optical disk is determined by using the focusing error signal amplitudes from at least two PDs. In this method, the identification can be carried out in an optical disk device originally having a function to manage a next-generation optical disk. However, the device is required to have three types of the PDs for the identification of three types (categories) of the disks. For this reason, it cannot be applied to a device that does not accept the next-generation optical disk.

Moreover, a method for identifying optical disks belonging to a same category (so-called DVD standard or CD standard) is disclosed in Japanese Laid-Open Patent Application JP-P2000-285582A. This discloses a technique for, in an optical disk device, identifying a DVD-ROM and a DVD-RAM by only carrying out a focus control and using the difference of the RF signal amplitude. In this method using the reflectivity of the disk, variation of reflectivity of manufactured optical disks, variation of sensitivity of pickups and light receivers, and variation of optical disks in correction exist, which results in false determination in an actual operation easily. It is one reason that various optical disks are now available a lot as the spread of the optical disks and a boundary serving as a criterion for the determination is being narrowed, however, in a method mainly using the amplitude, that is, using the reflectivity difference, the determination accuracy tends to deteriorate and it is hard to apply the method as high-speed determination.

Furthermore, in Japanese Laid-Open Patent Application JP-P2004-227640A, a technique for identifying a fake optical disk and a real optical disk is disclosed as a technique for determining an optical disk by using its characteristics. In a part of a land track of a management information region provided out of a data recording region in the optical disk, a flat portion (a mirror region: an extremely minute region intermittently provided toward a disk circumferential direction) broader than a track width cut toward a direction of the track is formed. In the land track including the mirror region, identification information specific to the disk is recorded by an irreversible record mark. When tracking is carried out under a specific condition, a regular disk is determined based on a slice level set between a land track signal level and a signal level of the irreversible record mark of the signal level in the mirror portion. in this method, since the identification mechanism is incorporated in the optical disk itself, it is required for all media manufacturers to put this method into practice. Thus, the method is not necessarily effective as the method for identifying plural types of optical disks including optical disks already on markets.

Moreover, in Japanese Laid-Open Patent Application JP-P2006-18931A, a technique for determining the disk type at high speed is disclosed. In this technique, a noise component included in an amount of the reflected light from the recording surface of an optical disk is detected. By judging the correlation between the detected noise component and the address portion in the DVD-RAM (CAPA), the optical disk is determined to be a DVD-RAM.

Besides these, in Japanese Laid-Open Patent Application JP-P2004-295952A, an optical disk determination method for determining plural types of optical disks is disclosed. In this determination method, time division irradiation of a plurality of lasers of different wavelengths to the optical disk is repeated with moving an objective lens close to or away from the recording surface of the optical disk. The type of the optical disk is determined by detecting the reflected light of the irradiation.

In Japanese Laid-Open Patent Application JP-P2006-31779A, an optical disk device which determines the disk based on the push-pull signal is disclosed. This optical disk device includes an optical pickup, a focus control means, a signal generation means, and a disk determination means. The optical pickup irradiates laser light to a disk. The focus control means carries out a focus control of the laser light to the disk. The signal generation means receives the light returned from the disk to generate and output a radial push-pull signal. The disk determination means determines the disk type based on the push-pull signal outputted from the signal generation means when a laser light of a predetermined wavelength is focused on the disk.

Here, the format structure of an optical disk will be explained. Most of the optical disks include: a data recording region where information is recorded by a line of pits (including a signal made of marks or spaces); and a management region (a management information region) where management information related to the optical disk (for example, the shape, the type of the ROM medium/recordable medium, and the size of the marks). Meanwhile, in this management information region, minor naming differences exist dependently on the type of the optical disk.

Next, as another background technique, a servo technique will be simply explained. For reading information from an optical disk, an optical disk device carries out the focus control in the optical axis direction, and then carries out the tracking control in the radial direction. As representative examples of the focus control method, the astigmatic method, the knife-edge method and the like exist. For the tracking control, the differential phase detection method, the push-pull method and the like exist. In particular, different tracking control is used in a case where the pit is employed and in a case where the groove is employed. The differential phase detection method is used in a case where the pit is employed (including a case where there are the signal made of marks or spaces). Thus, except for a case where a process called finalizing has not been carried out, by adopting the differential phase detection method, stable tracking of the management information region can be carried out.

### DISCLOSURE OF INVENTION

An object of the present invention is to provide an optical disk device and an optical disk type determination method which are able to identify the type of an optical disk at a high speed.

In addition, another object of the present invention is to provide an optical disk device and an optical disk type determination method which are able to identify the type of an optical disk easily with a high accuracy without being provided with a complex mechanism and a special working.

According to an aspect of the present invention, an optical disk device includes an optical head unit, a drive means, a recording surface state determination means and a controlling means, and determines a type of an optical disk based on a state of an information recording surface of the optical disk. The information recording surface includes a management region and a data recording region. The management region includes a track formed by a guiding groove or a prepit sequence and on which management information of the optical disk is recorded. The data recording region includes a track formed by a guiding groove or a prepit sequence and on which a user data is recorded. The optical head unit irradiates a focused beam onto an information recording surface of an optical disk which rotates. The drive means configured to move the focused beam along a radial direction of the optical disk by driving the optical head unit. The recording surface state determination means configured to determine a state of the information recording surface based on a reflected light of the focused beam. The controlling means determines a type of the optical disk based on a state of the information recording surface in a determination region being set to straddle between a management region and the data recording region which are determined by the recording surface state determination means.

According to another aspect of the present invention, an optical disk type determination method includes: a step of rotating an optical disk, a step of irradiating a focused beam, a surface state determination step and a type determination step. The optical disk includes a management region and a data recording region. The management region includes a track formed by a guiding groove or a prepit sequence and on which management information of the optical disk is recorded. The data recording region includes a track formed by a guiding groove or a prepit sequence and on which a user data is recorded. The step of irradiating the focused beam is a step of irradiating the focused beam onto the optical disk which rotates with moving the focused beam along a radial direction of the optical disk. The surface state determination step is a step of determining the state of the information recording surface based on a reflected light of the focused beam reflected by the information recording surface of the optical disk. The type determination step is a step of determining the type of the optical disk based on the determination result of the state of the information recording surface in a determination region being set to straddle between the management region and the data recording region.

In this manner, according to the present invention, an optical disk device and an optical disk type determination method which are able to identify the type of optical disk at the high speed can be provided. In addition, according to the present invention, an optical disk device and an optical disk type determination method which are able to identify the type of an optical disk easily with a high accuracy without being provided with a complex mechanism and a special working can be provided. Moreover, according to the present invention, an optical disk type determination method able to identify the type of an optical disk can be provided even to a device that does not have ability to reproduce a next-generation optical disk.

### BRIEF DESCRIPTION OF DRAWINGS

The above mentioned purposes, effects, and features of the invention will be clarified from the description of exemplary embodiments in cooperation with the attached drawings.

FIG. 1 is a schematic view explaining the structure of an optical disk according to an exemplary embodiment of the present invention;

FIGS. 2A to 2C show the structure of an optical disk according to an exemplary embodiment of the present invention one-dimensionally for explanation;

FIG. 3 is a block diagram showing a schematic configuration of an optical disk device according to an exemplary embodiment of the present invention;

FIG. 4 is a block diagram showing a schematic configuration of an optical head unit according to an exemplary embodiment of the present invention;

FIG. 5 is a block diagram showing a schematic configuration of a recording surface state determination unit according to an exemplary embodiment of the present invention;

FIGS. 6A to 6B are views showing an input-output signal of a recording surface state determination unit according to an exemplary embodiment of the present invention;

FIGS. 7A to 7C are views showing an input signal of a recording surface state determination unit when a target region has been scanned according to an exemplary embodiment of the present invention;

FIG. 8 is a drawing (1) showing an operation of an optical disk device according to an exemplary embodiment of the present invention; and

FIG. 9 is a drawing (2) showing an operation of an optical disk device according to an exemplary embodiment of the present invention.

### BEST MODE FOR CARRYING OUT THE INVENTION

Referring to the attached drawings, exemplary embodiments of the present invention will be explained below.

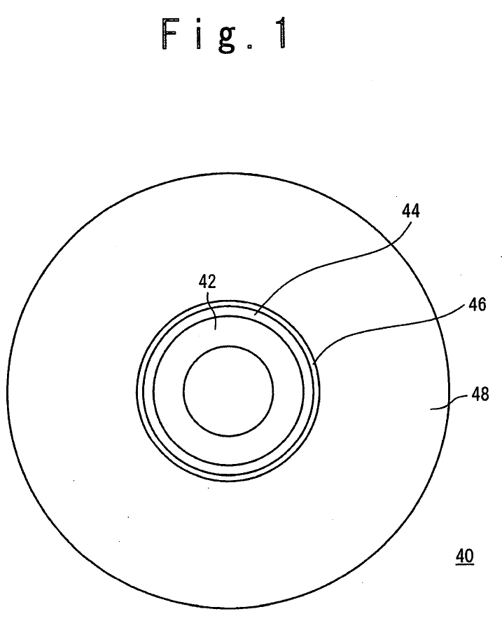

At first, a focused point in the present invention will be explained. In the foregoing explanation, a method for determining an optical disk by focusing the substrate thickness is described, which is effective for the determination of the disk of the substrate thickness 1.2 mm and the disk formed by laminating two disks whose respective substrate thicknesses are 0.6 mm, that is, the determination between disks having different substrate thicknesses. However, the DVD series optical disk has a same substrate thickness, in which the HD DVD, the DVD-RAM, and other DVDs are included, which have a similar physical structure but whose formats are different from each other. As shown in FIG. 1, an optical disk of the DVD series includes: a data recording region 48 where user data is recorded; a management region 44 where management information such as information used for managing an optical disk 40 or indicating a recording state of the data recording region 48 is recorded and being arranged on an inner circumference side; and an unused region 42, on a further inner circumference side. The optical disks of the HD DVD and the DVD-RAM further include a mirror region 46 between the data recording region 48 and the management region 44.

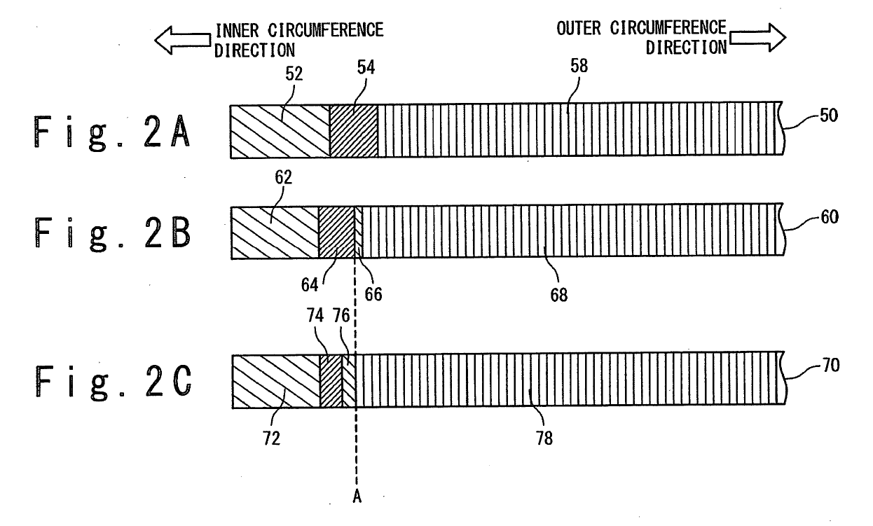

As shown in FIGS. 2A to 2C, the regions of such optical disks are schematically shown in one dimension. In FIG. 2A, the region of other DVD disk 50 is shown. The other DVD disk 50 includes: an unused region 52 that is provided on an inner circumference side of the optical disk and where information is not recorded; a management region 54 where management information of the DVD disk 50 is recorded; and a data recording region 58 where user data is recorded. As shown in FIG. 2B, a DVD-RAM disk 60 includes: an unused region 62 that is provided on an inner circumference side of the optical disk and where information is not recorded; a management region 64 where management information of the DVD-RAM disk 60 is recorded; a mirror region 66 that has no pit and no guide groove and where no information is recorded; and a data recording region 68 where user data is recorded. As shown in FIG. 2C, an HD DVD disk 70 includes similar regions to the DVD-RAM disk 60, namely, an unused region 72, a management region 74, a mirror region 76, and a data recording region 78. The mirror region 76 of the DVD disk 70 is provided on the inner circumference side than the mirror region 66 of the DVD-RAM disk 60. That is, the boundary A on outer circumference side of the mirror region 76 of the DVD disk 70 is on the inner circumference side than the boundary of the inner circumference side of the mirror region 66 of the DVD-RAM disk 60.

Accordingly, it is found that the DVD disk 70 and the DVD-RAM disk 60 are different from the other DVD disk 50 in an existence of the mirror regions 76 and 66 and can be determined by detecting the mirror regions 76 and 66. The HD DVD disk 70 and the DVD-RAM disk 60 can be determined by comparing the detected positions of the mirror region 76 and 66. Here, a region having a recording state different from a normal recording state (a recording state in the data recording region), that is, a region where a normal data recording is not carried out and that has management information is assumed to be a management region (the management information region).

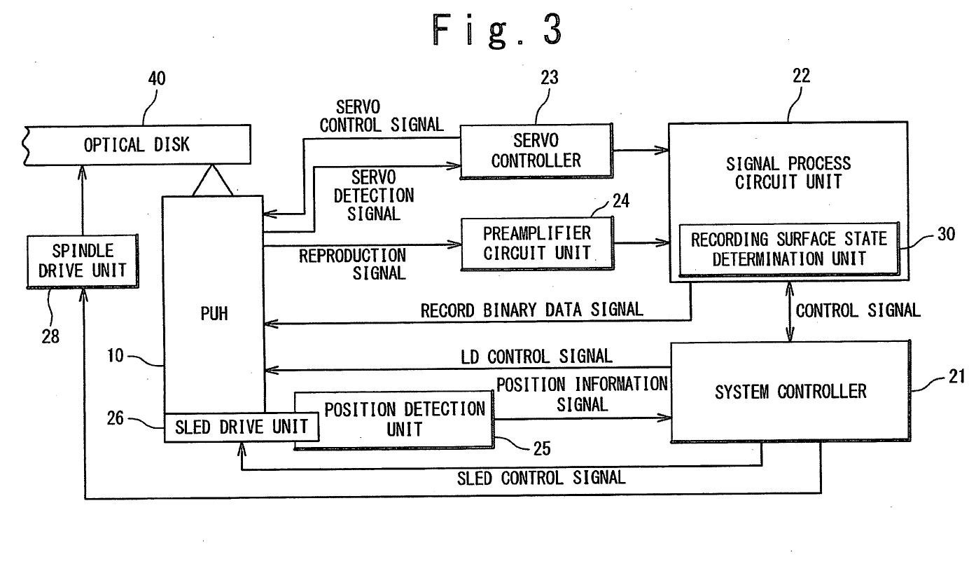

FIG. 3 shows a schematic configuration of an optical disk is device for determining the type of an optical disk by focusing on the difference of the physical structure of the optical disk as explained above. The optical disk device includes an optical head unit (PUH: Pick Up Head) 10, a spindle drive unit 28, a preamplifier circuit unit 24, a sled drive unit 26, a position detection unit 25, a servo controller 23, a signal process circuit unit 22 including a recording surface state determination unit 30, and a system controller 21.

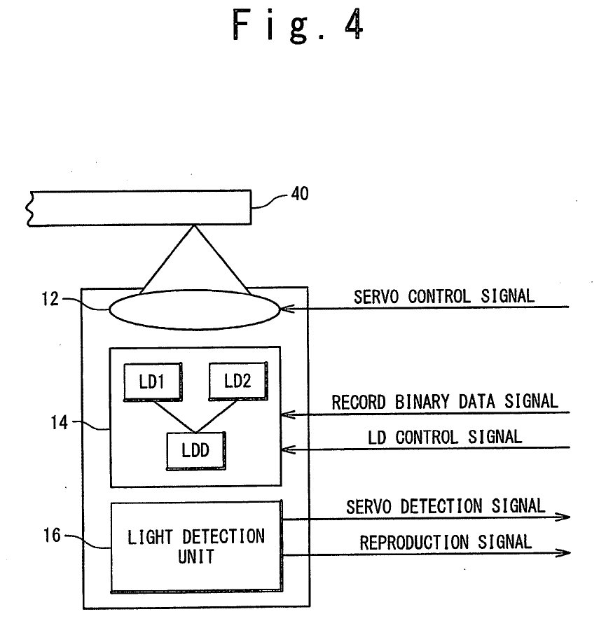

As shown in FIG. 4, the optical head unit 10 includes an objective lens 12, a laser diode (LD) drive unit 14, and a light detection unit 16, and irradiates laser light to an optical disk 40. The objective lens 12 moves along the optical axis direction based on a servo control signal, and adjusts focusing of the laser light on the optical disk 40. The LD drive unit 14 mounts a plurality of laser diodes LD1 and LD2 so as to accept plural types of the optical disks 40. For example, the laser diode LD1 is used for CD series optical disks and the laser diode LD2 is used for DVD series optical disks. In addition, the LD drive unit 14 includes an LD drive circuit LDD for switching and driving the laser diodes LD1 and LD2 based on an LD control signal outputted from the system controller 21. When recording to the optical disk 40 is carried out, the LD drive circuit LDD drives the laser diodes LD1 and LD2 based on a record binary data signal supplied from the signal process circuit unit 22. The light detection unit 16 detects the reflected light reflected by the optical disk 40 to generate a reproduction signal and a servo detection signal. The reproduction signal is outputted to the preamplifier circuit unit 24, and the servo detection signal is outputted to the servo controller 23.

The spindle drive unit 28 drives the optical disk 40 rotationally in response to the control of the system controller 21. The preamplifier circuit unit 24 carries out processes such as filtering to the inputted reproduction signal and outputs it to the signal process circuit unit 22. The sled drive unit 26 moves the optical head unit 10 along the radial direction of the optical disk 40 based on a sled control signal outputted from the system controller 21.

The position detection unit 25 detects the position of the optical head unit 10, and outputs a position information signal to the system controller 21. The position detection unit 25 includes a rotary encoder and the like. The position detection unit 25 can detect an approximate position of the optical head unit 10, for example, by counting the number of pulses generated when the sled drive unit 26 moves the optical head unit 10. Its accuracy can be ensured at approximately tens of μm, such position detection is well-known to those skilled in the art.

The servo controller 23 outputs a servo control signal based on a servo detection signal outputted from the optical head unit 10 to control the focal point of the light irradiated to the optical disk 40. In addition, the servo controller 23 outputs a track error signal and the like to the signal process unit 22.

The signal process circuit unit 22 includes a demodulator for demodulating an input signal, a modulator for modulating a signal to be recorded, an address extraction part for extracting characteristics of the address based on the difference of the format of the optical disk 40, and so on, which are not shown in the drawings. The signal process circuit unit 22 outputs a record binary data signal modulated by the modulator to the optical head unit 10. The signal process circuit unit 22 further includes a recording surface state determination unit 30 for determining the state of the recording surface of the optical disk, and outputs a determination result to the system controller 21.

The system controller 21 outputs an LD control signal to the optical head unit 10 to control a light source. The system controller 21 can recognize the position of the optical head unit 10, that is, the position of the light spot on the recording surface of the optical disk 40 based on a position information signal outputted from the position detection unit 25. The system controller 21 determines the type of the optical disk based on the determination result of the state of the optical disk recording surface outputted from the recording surface state determination unit 30. In addition, the system controller 21 integrally controls whole of the optical disk device.

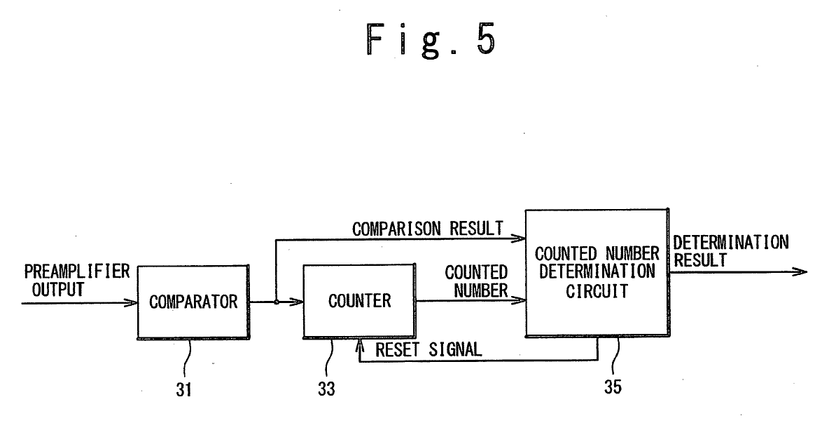

As shown in FIG. 5, the recording surface state determination unit 30 includes a comparator 31, a counter 33, and a counted number determination circuit 35. The comparator 31 inputs a reproduction signal processed by the preamplifier circuit unit 24. The comparator 31 compares the input signal with a predetermined comparison level, and outputs the comparison result to the counter 33 and the counted number determination circuit 35. The counter 33 counts the number of pulses of the comparison result per unit time. Alternatively, a width (time) of each pulse may be obtained by inputting a predetermined clock signal and counting the number of clocks. The counted number determination circuit 35 inputs the counted number outputted from the counter 33 and the comparison result outputted from the comparator 31 to determine the state of the recording surface of the optical disk 40. Here, the counted number determination circuit 35 periodically checks the counted number of the counter 33 and the comparison result of the comparator 31 and resets the counter 33 to determine the state of the recording surface.

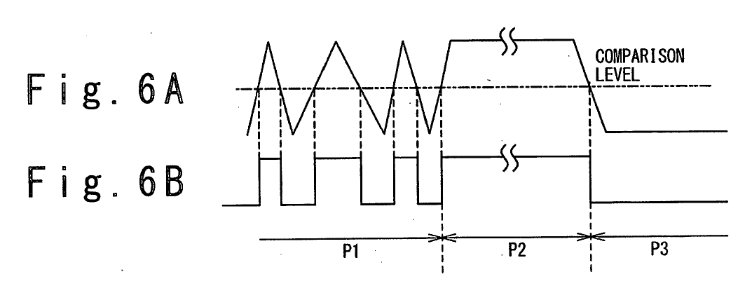

Referring to FIG. 6, operations of the recording surface state determination unit 30 will be explained. FIG. 6 shows a waveform example of input and output signals of the recording surface state determination unit 30. As shown in FIG. 6(a), an input signal is inputted from the preamplifier circuit unit 24. The waveform in a period P1 shows that an area on which data is recorded on the optical disk 40 is being scanned, the waveform showing a relatively high frequency. The waveform in a period P2 shows that the mirror region is being scanned, and the input signal is at a high level and shows almost no change. Since the mirror region has a predetermined width along the radial direction of the optical disk 40, the waveform does not change in a predetermined width. The waveform in a period P3 shows that the scanning region does not record data, and the input signal is at a low level and shows almost no change.

The comparator 31 compares this input signal with a predetermined comparison level, and outputs a high level when the signal exceeds the comparison level and outputs a low level when the signal is less than the comparison level. Accordingly, the high level is continuously outputted when the mirror region is being scanned, the low level is continuously outputted when an unrecorded region is being scanned, and the high level and the low level are alternately outputted when a recorded region is being scanned. Meanwhile, since a data recording region of the DVD-RAM has a CAPA header even when user data is not recorded yet, the high level is outputted once in a while in an output that is basically at the low level.

That is, the state of the recording surface can be determined depending on whether or not this output of the comparator 31 frequently changes and depending on which level the output shows, high or low, when not changing. When the high-level and unchanged period exceeds a predetermined time, it is recognized that the mirror region is being scanned. This predetermined time corresponds to the number of times at which the counted number determination circuit 35 observes the counted number and the comparison result. It can be determined by observing the counted number of the counter 33 whether or not the output of the comparator 31 frequently changes, and the level can be determined by observing the determination result of the comparator 31. That is, the counted number determination circuit 35 determines the state of the recording surface based on such information.

The recording surface state determination unit 30 can be configured by using one of or both of a peak hold signal and a bottom hold signal and by combining an analog computing circuit and a comparator. Alternatively, the recording surface state determination unit 30 can determine the state of the recording surface by including a switch device for switching an input signal and by using a signal obtained from the servo controller (for example, a track error signal) as an input signal. In all cases where such a signal has been inputted, the recording surface state determination unit 30 determines the region as a prepit-forming region in the case where a preliminarily-supposed number of signal detection has been obtained or in the case where a signal has been obtained as a high-frequency waveform, and determines the region as a mirror region (a signal unchanged region) in a case where the signal has not been detected, and carries out an operation for outputting the determination result from the counted number determination circuit 35.

Additionally, instead of the counted number determination circuit 35, the system controller 21 may periodically import the output of the counter and determine the prepit-forming region and the mirror region (the signal unchanged region) based on the counted number. In this case, the system controller 21 resets the counter 33 immediately after the import of the counted number.

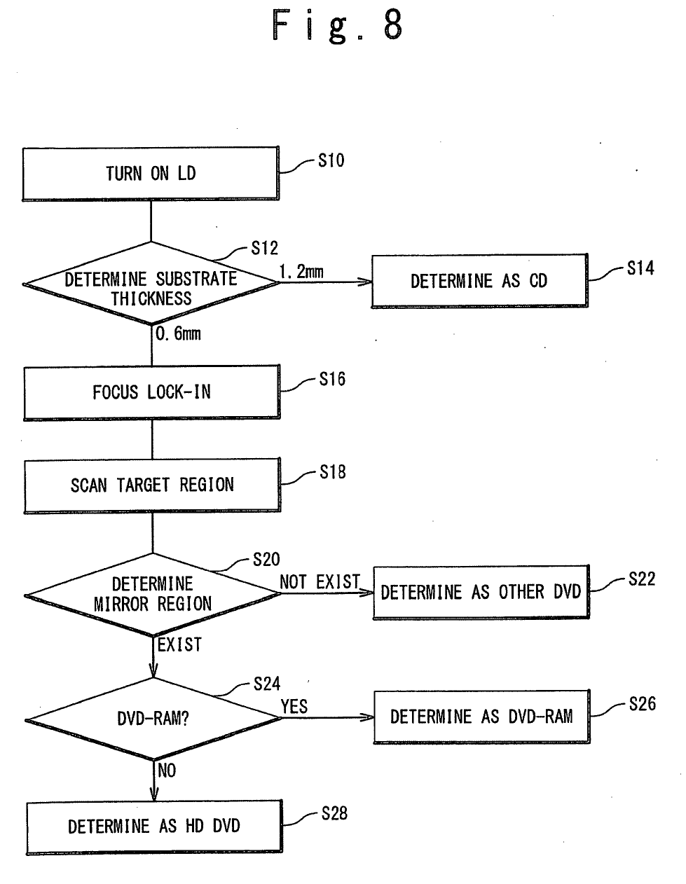

Next, referring to FIG. 8, operations for determining the type of an optical disk in the optical disk device will be explained.

When the optical disk 40 is loaded on the optical disk device, the system controller 21 rotates the optical disk 40 and sets the optical head unit 10 to a portion outer than 40 mm from the center of the optical disk 40. As the optical disk 40, a disk of 80 mm diameter and a disk of 120 mm diameter are included, and this initial position setting is carried out to identify the diameter of the optical disk 40. The optical head 10 is set to the data recording region in the case of the 120 mm diameter disk and set to an outside of the disk in the case of the 80 mm diameter disk.

This identification of the disk diameter may also be determined by measuring the time required for the rotation speed of the optical disk to reach a certain speed. Alternatively, the diameter can also be determined by the fact that, under a condition that the light source is turned on, reflected light from the optical disk can be obtained if the recording surface of the optical disk exists on the source's position and the reflected light from the optical disk cannot be obtained if the recording surface does not exist on the position. When the determination of the optical disk is not carried out, an innermost periphery to which the optical head unit 10 can move may be set as an initial position of the optical head unit 10, and a position near the management region 44 may be set as the initial position of the optical head unit 10.

At the step S10, the LD drive circuit LDD turns on the laser diode LD2 for DVD in response to an instruction from the system controller 21.

At the step S12, the servo controller 23 moves the objective lens 12 upward and downward along the optical axis direction, and determines whether the substrate thickness is 0.6 mm or 1.2 mm based on the size of a focus S-shape and of a summation of the reflected light intensity from the optical disk 40. When the substrate thickness is determined to be 1.2 mm, the process proceeds to the step S14 and the optical disk 40 is determined to be a CD series. When the substrate thickness is determined to be 0.6 mm, the process proceeds to the step S16 and the optical disk 40 is determined to be a DVD series.

At the step S14, the LD drive circuit LDD turns off the laser diode LD2 for the optical disk of the DVD series in response to an instruction from the system controller 21, and turns on the laser diode LD1 for the optical disk of the CD series. Then, the system controller 21 carries out an operation for the optical disk of the CD series.

At the step S16, the focus lock-in adjusted to the substrate thickness of 0.6 mm is carried out to the optical disk of the DVD series. Subsequently, at the step S18, the system controller 21 scans a target region by applying only the focusing servo. The target region is set to a region from a predetermined radial position of the management region 44 of the optical disk 40 to a predetermined radial position of the data recording region 48 or set to a region from a predetermined radial position of the data recording region 48 to a predetermined radial position of the management region 44. Accordingly, the optical head unit 10 moves in the target region set on the rotating optical disk 40 along the radial direction. As a result, the light spot irradiated from the optical head unit 10 spirally and concentrically scans the recording surface of the optical disk 40.

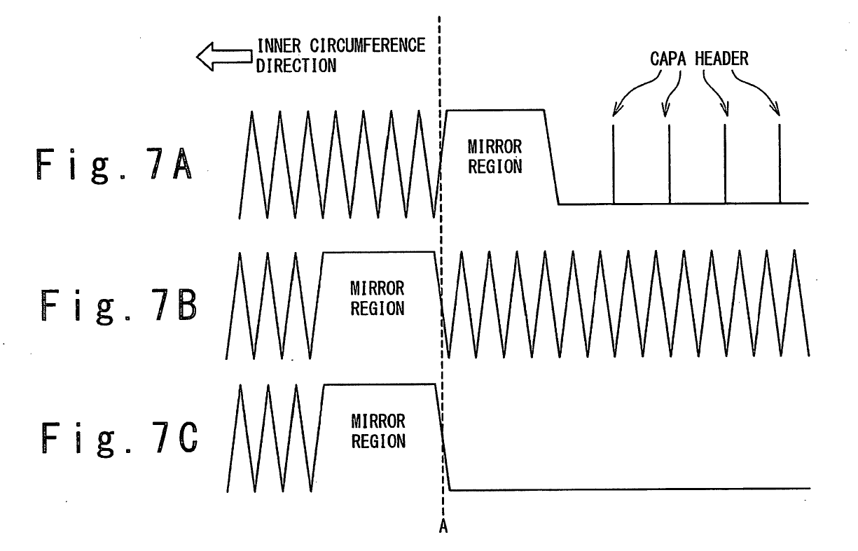

FIGS. 7A to 7C show waveforms of the signal outputted from the preamplifier circuit unit 24 when the target regions set on the DVD-RAM disk 60 and the HD DVD disk 70 which are the DVD series are scanned by applying only the focusing servo. When the scanning is carried out from the management regions 64 and 74 sides to the outer circumference side, the signals are outputted in the direction from left to right in FIGS. 7A to 7C. When the scanning is carried out from the management regions 68 and 78 sides to the inner circumference side, the signals are outputted in the direction from right to left in FIGS. 7A to 7C. Here, the initial position of the optical head unit 10 is set to a position away from the center of the optical disk 40 at approximately 40 mm, and the optical head 10 scans the disk from the outer circumference side to the inner circumference side.

In FIG. 7A, a signal waveform in the scanning of the target region in the DVD-RAM disk 60 is shown. The signal waveform in a case where a signal is not recorded on the data recording region 68 is shown in FIG. 7A. Since the CAPA header is arranged in the data recording region 68 of the DVD-RAM disk 60, an impulse-shaped waveform representing the CAPA header is found in spots. In FIG. 7B, a signal waveform in the scanning of the target region in the HD DVD disk 70 where a signal is recorded on the data recording region 78 is shown. In FIG. 7C, a signal waveform in the scanning of the target region in the HD DVD disk 70 where a signal is not recorded on the data recording region 78 is shown. It is found that a waveform of a higher frequency can be obtained in the region where a signal is recorded than in other region. Meanwhile, in a case of other DVD disks 50, a waveform without a portion corresponding to this mirror region is outputted.

At the step S20, the system controller 21 determines whether or not the mirror region 46 is detected in the target region. In the case where the optical disk 40 is a DVD-RAM disk 60 or an HD DVD disk 70, a period where the reflected light from the optical disk 40 does not substantially change continues for a certain time or more as shown in FIGS. 7A to 7C, and detection of the mirror region 46 is notified from the recording surface state determination unit 30. In that case, the process proceeds to the step S24. When the scanning of the target region is finished without the notification of the detection of the mirror region 46 from the recording surface state determination unit 30, the loaded optical disk 40 is determined to be the other DVD 50 and the process proceeds to the step S22. At the step S22, an operation for the other DVD disk 50 continues.

At the step S24, it is determined whether the optical disk 40 is a DVD-RAM disk 60 or an HD DVD 70. Since provided with the CAPA header, the DVD-RAM disk 60 can be determined by the detection of the CAPA header. The CAPA header detection technique is commonly-known by those skilled in the art, and thus the explanation thereof is omitted here. When the CAPA header is detected, the disk is determined to be a DVD-RAM disk 60 and the process proceeds to the step S26, and a process for the DVD-RAM disk 60 is carried out. When the disk is not the DVD-RAM disk 60, the process proceeds to the step S28 and a process for the HD DVD disk 70 is carried out.

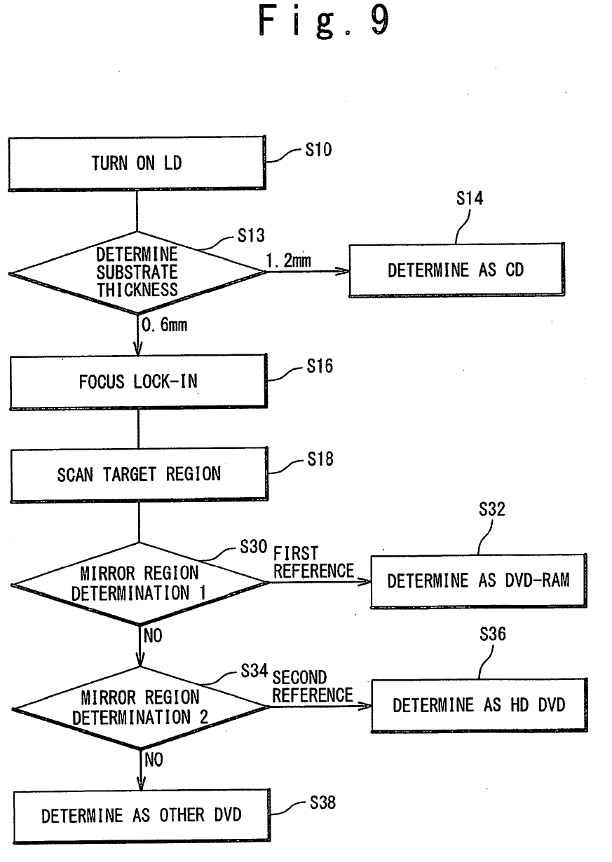

In addition, as show in FIG. 9, it is also possible to use the timing when the mirror region is detected for the determination method of the disk type of an optical disk which has the mirror region. Since the process from the step S10 to the step S18 in FIG. 9 is the same as the process from the step S10 to the step S18 in FIG. 8, the explanation thereof is omitted.

As described above, the signal waveforms obtained when the target region is scanned are shown in FIGS. 7A to 7C. As will be expected from FIGS. 7A to 7C, when the target region is scanned from the outer circumference side to the inner circumference side, the mirror region 66 of the DVD-RAM disk 60 is detected earlier than the mirror region 76 of the HD DVD disk 70. That is because the mirror region 76 of the HD DVD disk 70 is provided to the inner circumference side than the mirror region 66 of the DVD-RAM 60. Accordingly, when the mirror region is detected on the outer circumference side than a position indicated by the dashed line A in FIGS. 7A to 7C, it can be determined that the disk is a DVD-RAM disk 60, and when the mirror region is detected on the inner circumference side than the position, it can be determined that the disk is an HD DVD disk 70.

At the step S30, it is determined whether or not the mirror region can be detected before a first reference position. The first reference point is, for example, the position represented by the dashed line A in FIGS. 7A to 7C. When the mirror region has been detected before the position of the optical head unit 10 reaches the first reference position, the system controller 21 determines the loaded optical disk 40 to be a DVD-RAM disk 60 and the process proceeds to the step S32. At the step S32, a process for the DVD-RAM disk 60 is carried out. When the scanning position crosses the first reference position, the process proceeds to the step S34.

At the step S34, it is determined whether or not the mirror region can be detected before a second reference position. The second reference point is, for example, a position on the outermost periphery of the management region 74 of the HD DVD disk 70. When the mirror region has been detected before the position of the optical head unit 10 reaches the second reference position, the system controller 21 determines the loaded optical disk 40 to be an HD DVD disk 70 and the process proceeds to the step S36. At the step S36, a process for the HD DVD disk 70 is carried out. In a case where the mirror region is not detected before the second reference position, the loaded optical disk 40 is determined to be the other DVD disk 50 without the mirror region, the process proceeds to the step S38, and a process for the other DVD disk 50 is carried out.

Here, the explanation has been made supposing the optical head unit 10 scans from the outer circumference side to the inner circumference side, however, the system controller 21 can similarly determine the type of an optical disk when the scanning is carried out in the reversed direction, from the inner circumference side to the outer circumference side. For example, the system controller 21 determines a disk to be an HD DVD disk 70 when the mirror region is detected before the scanning of the target region reaches the position represented by the dashed line A, determines the disk to be a DVD-RAM disk 60 when the region is detected after the position, and determines the disk to be the other DVD disk 50 when the mirror region has not been detected in the target region. In this determination method, the determination of the disk can be realized easily and at a higher speed without carrying out an address determination such as the CAPA detection.

As described above, the determination of the HD DVD disk 70, the DVD-RAM disk 60, the other DVD disk 50, and the disk of the CD series can be realized. Here, the system controller 21 determines the recording surface state based on the magnitude of the intensity change of the reflected light from the optical disk 40, and determined a disk type in the above-described manner.

The change of the light intensity is not determined by an absolute value of the amplitude but determined by a relative value, and accordingly does not depend on the reflectance. Accordingly, it is found that the identification of the disk type without depending on the reflectance can be realized. This shows that the detection can also be realized by using not the intensity of the reflected light but a track error signal. Specifically, after the target region set to the optical disk 40 is scanned in the similar manner to the determination based on the change of the light intensity, when a significant push-pull track error signal or a differential phase track error cannot be obtained because a track is not detected on the recording surface, it also can be determined that its position is the mirror region. Accordingly, the type of a disk can be identified based on these track error signals.

### EXAMPLE 1

An actual operation test was carried out by using a device for determining the type of an optical disk as described above. This optical disk device carries out the determination of the DVD-RAM disk and the HD DVD disk based on the detection of the CAPA header. The optical head unit 10 mounts a laser diode LD1 outputting laser light with 780 nm wavelength and a laser diode LD2 outputs laser light with 650 nm wavelength. As the optical disk 40, a disk where: a guide groove for land groove formatting is formed on a polycarbonate substrate whose diameter is 120 mm and thickness is 0.6 mm; the track pitch in the data recording region is 0.34 μm; and data is not recorded in the data recording region yet was prepared. When this optical disk 40 is loaded on the optical disk device, the optical head unit 10 preliminarily moves to a radial position of approximately 45 mm. The spindle drive unit 28 rotates the optical disk 40, and the system controller 21 turns on the laser diode LD2 to check the existence of the reflected light. Since the diameter of the disk is 120 mm, the reflected light exists, and the system controller 21 accordingly determines the disk to be a disk with 120 mm diameter. The system controller 21 further checked the substrate thickness based on the S-shaped waveform and the like to determine the substrate thickness to be 0.6 mm.

After that, the focus lock-in is carried out by controlling the focus, and the system controller 21 moves the optical head unit 10 to a region in the inner side position of the management region as a target region and the return light from the disk is detected simultaneously. In this scanning, it was notified from an output of the recording surface state determination unit 30 that a period where reflected light from the optical disk 40 does not substantially change continues for a certain time or more, and the system controller 21 determined the disk to be a disk of the HD DVD or the DVD-RAM.

The system controller 21 moved the optical head unit 10 to the data recording region again, and carried out a detection process of the CAPA header that is a feature of the DVD-RAM. Since the CAPA header could not be detected from this optical disk 40, the system controller 21 determined the loaded optical disk 40 to be an optical disk of the HD DVD series. Since the optical disk device used for the present examination cannot carry out recording and reproducing of the HD DVD, the device released the loaded optical disk 40 as a process for the HD DVD after determining the disk type.

Next, a DVD-ROM disk (0.74 μm track pitch) where a pit is formed on a polycarbonate substrate whose diameter is 120 mm and thickness is 0.6 mm was prepared. When the determination operation of the disk type has been carried out as described above, it was not notified from the recording surface state determination unit 30 a result that the mirror region where a period during which the reflected light from the optical disk does not substantially change continues for a certain time or more was detected. The system controller 21 determined the disk to be the other DVD disk (the DVD-ROM disk) to carry out a DVD reproduction process. Based on a series of these operations, the effectiveness and effect of this determination method of the type of an optical disk were verified.

### EXAMPLE 2

Next, an actual operation test of the optical disk device for determining the DVD-RAM disk and the HD DVD disk based on the radial position of the mirror region was carried out. The optical head unit 10 mounts a laser diode LD1 outputting the laser light with the 780 nm wavelength and a laser diode LD2 outputting the laser light with the 650 nm wavelength. The optical disk 40 is provided with a guide groove for in-groove formatting on the polycarbonate substrate whose diameter is 120 mm and thickness is 0.6 mm. Data had been already recorded in a data recording region having a track of 0.4 μm track pitch.

The optical disk 40 is loaded on the optical disk device, and the optical head unit 10 preliminarily moves to a radial position of approximately 45 mm. The spindle drive unit 28 rotates the optical disk 40, and the system controller 21 turns on the laser diode LD2 to check the existence of the reflected light. The system controller 21 detects the reflected light and determined the disk to be a disk with 120 mm diameter. The system controller 21 further checked the substrate thickness based on the S-shaped waveform and the like to determine the substrate thickness to be 0.6 mm.

After that, the system controller 21 turns off the laser diode LD2 and moves the optical head unit 10 to 24.2 mm radial position. Here, the system controller 21 turns on the laser diode LD2 again, and carries out the focus lock-in by a focus control. The system controller 21 moves the optical head unit 10 from this position to a region in the inner side near of the management region (23 mm radial position) as a target region and the return light from the optical disk 40 is observed simultaneously. There is the mirror region in the inner side near position of the 24.2 mm radial position of the DVD-RAM disk, and a vicinity of the 24.2 mm radial position of the HD DVD disk is a data recording region.

In the scanning of the target region, a signal where a period during which the reflected light from the optical disk does not substantially change continues for a certain time or more after a high-frequency waveform continued was outputted from the optical head unit 10. Accordingly, after outputting a result showing a data recording state, the recording surface state determination unit 30 outputted a result showing the mirror region was detected. Based on this result, the system controller 21 determined the state to be a state equivalent to that of FIG. 7B and determined the disk to be a disk of the HD DVD series. Since the optical disk device used of the present examination cannot carry out recording and reproducing of the HD DVD, the device released the loaded optical disk 40 as a process for the HD DVD after determining the disk type.

Next, a DVD-RAM disk (0.615 μm track pitch) where data was not recorded to its data recording region was prepared. When the determination operation of the disk type was carried out as described above, the recording surface state determination unit 30 outputted a result of the mirror region detection from immediately after the scanning of the target region and the system controller 21 determined the state to be a state equivalent to FIG. 7A, that is, the DVD-RAM disk. After that, the system controller 21 carried out a process for the DVD-RAM. Based on a series of these operations, the effectiveness and effect of this determination method of the type of an optical disk were confirmed.

### EXAMPLE 3

Next, an actual operation test of the optical disk device for determining the existence of the mirror region based on a track error signal was carried out. This optical disk device is dedicated to reproduction, the optical head unit 10 mounts a laser diode LD1 outputting the laser light with the 780 nm wavelength and a laser diode LD2 outputting the laser light with the 650 nm wavelength. The optical disk 40 is provided with a guide groove for in-groove formatting on a polycarbonate substrate whose diameter is 120 mm and thickness is 0.6 mm. Data had already recorded to a data recording region having a track of 0.4 μm track pitch.

The optical disk 40 is loaded on the optical disk device, and the optical head unit 10 preliminarily moves to a vicinity of 45 mm radial position that is an initial position. The spindle drive unit 28 rotates the optical disk 40, and the system controller 21 turns on the laser diode LD2 to check the existence of the reflected light. The system controller 21 determined the disk to be a disk with 120 mm diameter because the reflected light was detected. The system controller 21 further checked the substrate thickness based on the S-shaped waveform and the like to determine the substrate thickness to be 0.6 mm.

After that, the system controller 21 turns off the laser diode LD2 and moves the optical head unit 10 to 24.2 mm radial position. Here, the system controller 21 turns on the laser diode LD2 again, and carries out the focus lock-in by a focus control. The system controller 21 moves the optical head unit 10 from this position to a region inner side near the position of the management region (23 mm radius position) as a target region and return light from the optical disk 40 is observed simultaneously.

In a position near the start position of this target region, track lock-in based on a differential phase tracking was carried out. At this time, the recording surface state determination unit 30 detected a high-frequency waveform and outputted a result showing a data recording state. Subsequently, the system controller 21 stopped the tracking servo only and moves the optical head unit 10 to the region near the management region of the DVD-RAM disk toward an inner circumference side with applying a focus servo. The system controller 21 carries out the lock-in operation of the track servo at the radial position. At this time, the lock-in of the track servo cannot be carried out, and the recording surface state determination unit 30 outputs a mirror region detection. The system controller 21 determined the state to be the state equivalent to FIG. 7B, and determined the disk to be a disk of the HD DVD series. Since the optical disk device used in the present examination cannot reproduce the HD DVD, the device released the loaded optical disk 40 as a process for HD DVD. Accordingly, the effect of the determination method of the type of an optical disk using a track error signal was verified.

In the present exemplary embodiment, the wavelength of the laser light outputted from he laser diode LD is set to be two types, 780 nm and 650 nm, however, a laser diode of 405 nm wavelength may be combined with either one of the two types. In addition, an exemplary embodiment can be applied to a device mounting three types of laser diodes of 780 nm, 650 nm, and 405 nm wavelengths. In the case of mounting the laser diode of 405 nm wavelength (hereinafter referred to as BLD), the turning on the laser diode at the step S10 may be replaced by the turning on this BLD. Needless to say, after the disk was determined to be the HD DVD disk, the process for the HD DVD can be subsequently carried out by continuing the loading of the optical disk if a device is able to record and reproduce the disk of the HD DVD series.

Additionally, though a signal becomes sometimes unchanging by a scratch or a dirt spot, the determination can be carried out in view of the polarity of the signal in that case. Moreover, it may be determined whether or not the mirror region exists in a ring shape, for example, by replacing the scanning toward the radial direction by a step movement (moving for a certain period and stopping for a certain period) in a region near the preliminarily-assumed mirror region (the region where signal is unchanged). In that case, the determination can be carried out at a higher accuracy. Meanwhile, in the case of the step movement, there are sometimes three cases of the mirror region, a prepit region, and a mixture of the two in each single rotation of the disk because of decentering of the loaded optical disk, however, the mirror region existing between the management region and the data recording region can be detected even in such situation.

According to the present invention, an optical disk device and an optical disk type determination method which are able to identify the type of an optical disk at a high speed can be provided. In addition, according to the present invention, an optical disk device and an optical disk type determination method which are able to identify the type of an optical disk easily with a high accuracy without a complex mechanism and a special working can be provided. Moreover, according to the present invention, an optical disk type determination method able to identify the type of optical disk can be provided even to a device that does not have ability to reproduce a next-generation optical disk.

Referring to exemplary embodiments, the present invention has been described above, however, the present invention is not limited to the above-described exemplary embodiments. Various modifications which can be understood by a person skilled in the art can be carried out to the configurations and details of the present invention within the scope of the present invention.

1-16. (canceled)

17. An optical disk device comprising:
an optical head unit configured to irradiate a focused beam, onto an information recording surface of an optical disk which rotates, wherein the information recording surface includes a management region and a data recording region, the management region comprises a track formed by a guiding groove or a prepit sequence and on which management information of the optical disk is recorded, and the data recording region formed by a guiding groove or a prepit sequence and on which a user data is recorded;
a drive unit configured to move the focused beam along a radial direction of the optical disk by driving the optical head unit;
a recording surface state determination unit configured to determine a state of the information recording surface based on a reflected light of the focused beam; and
a controller configured to determine a type of the optical disk based on a state of the information recording surface in a determination region being set to straddle between a management region and the data recording region which are determined by the recording surface state determination unit by detecting an existence or absence of a mirror region in which the track does not exist, and by detecting a starting position of the mirror region when the mirror region is detected to exist.

18. The optical disk device according to claim 17, wherein the recording surface state determination unit is configured to detect an existence or absence of a signal unchanged period, in which the reflected light does not exhibit a change during a period when the focused beam scans the determination region, continues more than a predetermined time, to determine whether or not the mirror region is included in the determination region.

19. The optical disk device according to claim 18, wherein the recording surface state determination unit is configured to:
include a comparator configured to compare a light intensity of the reflected light with a predetermined reference level;
determine the state of the information recording surface as a region where a prepit is formed or the data recording region when the changing number indicating the number of a changing time of an output of the comparator exceeds a predetermined first changing number; and
determine the state of the information recording surface as the mirror region when the changing number is less than a predetermined second changing number and a light intensity of the reflected light does not reach to the predetermined reference level.

20. The optical disk device according to claim 18, wherein the recording surface state determination unit is configured to:
include a comparator configured to compare a light intensity of the reflected light with a predetermined reference level;
determine the state of the information recording surface as a region where a prepit is formed or the data recording region when a changing interval indicating an interval of a changing time of an output of the comparator does not reach to a predetermined first changing interval; and
determine the state of the information recording surface as the mirror region when the changing interval exceeds a predetermined second changing interval and a light intensity of the reflected light is more than the predetermined reference level.

21. The optical disk device according to claim 18, wherein the change of the reflected light is a change of a distribution of a light intensity in a reflected light far field, and
the recording surface state determination unit is configured to perform the following:
determining a region where a push-pull track error signal is effective as a guided groove formed region;
determining a region where a differential phase detection track error signal is effective as a prepit formed region; and
determining a region where a change of a distribution of a reflected light intensity is small and a push-pull track error signal and a differential phase track error signal are not effective as the mirror region.

22. The optical disk device according to claim 18, wherein the optical disk is any of a first optical disk and a second optical disk, the first optical disk has the mirror region whose shape is a ring having a predetermined width is the radial direction and arranged between the management region and the data recording region, and the second optical disk in which the management region and the data recording region is adjacent to each other, and
the control unit is configured to determine the optical disk as the first optical disk when the recording surface state determination unit detects the mirror region in the determination region, and determine the optical disk as the second optical disk when the mirror region is not detected.

23. The optical disk device according to claim 22, further comprising a position detection unit configured to detect a position of the focused beam by detecting a movement of the optical head unit,
wherein the first optical disk is any of a third optical disk and a fourth optical disk, wherein the third optical disk has the mirror region in a predetermined position along a radial direction, and the fourth optical disk has the mirror region in an inner circumference side than the predetermined position along the radial direction, and
the control unit is configured to determine the optical disk as the third optical disk or the fourth optical disk based on a position of the focused beam when the recording surface state determination unit detects the mirror region.

24. The optical disk device according to claim 22, further comprising a CAPA detection unit configured to detect an existence or absence of a CAPA header indicating an address of the data recording region,
wherein the first optical disk is any of a third optical disk having the CAPA header and a fourth optical disk not having the CAPA header, and
the control unit is configured to determine the optical disk as the third optical disk when the CAPA detection unit detects the CAPA header in the data recording region, and determine the optical disk as the fourth optical disk when the CAPA detection unit does not detect the CAPA header in the date recording region.

25. An optical disk type determination method comprising:
providing an optical head unit configured to irradiate a focused beam onto an information recording surface of an optical disk which rotates, wherein the information recording surface includes a management region and a data recording region, the management region comprises a track formed by a guiding groove or a prepit sequence and on which management information of the optical disk is recorded, and the data recording region formed by a guiding groove or a prepit sequence and on which a user data is recorded;
moving the focused beam along a radial direction of the optical disk by driving the optical head unit;
determining a state of the information recording surface based on a lo reflected light of the focused beam; and
determining a type of the optical disk based on a state of the information recording surface in a determination region being set to straddle between a management region and the data recording region which are determined by said determining the state of the information recording surface. by detecting an existence or absence of a mirror region in which the track does not exist, and by detecting a starting position of the mirror region when the mirror region is detected to exist.

26. The optical disk type determination method according to claim 25, wherein said determining a state of the information recording surface comprises:
detecting an existence or absence of a signal unchanged period, in which the reflected light does not exhibit a change during a period when the focused beam scans the determination region, continues more than a predetermined time; and
determining whether or not the mirror region is included in the determination region.

27. The optical disk type determination method according to claim 26, wherein said determining the state of the information recording surface comprises:
determining the state of the information recording surface as a region where a prepit is formed or the data recording region when the changing number indicating the number of a changing time of an output of a comparator exceeds a predetermined first changing number, wherein the comparator is configured to compare a light intensity of the reflected light with a predetermined reference level; and
determining the state of the information recording surface as the mirror region when the changing number is less than a predetermined second changing number and a light intensity of the reflected light does not reach to the predetermined reference level.

28. The optical disk type determination method according to claim 26, wherein said determining the state of the information recording surface comprises:
determining the state of the information recording surface as a region where a prepit is formed or the data recording region when a changing interval indicating an interval of a changing time of an output of a comparator does not reach to a predetermined first changing interval, wherein the comparator is configured to compare a light intensity of the reflected light with a predetermined reference level; and
determining the state of the information recording surface as the mirror region when the changing interval exceeds a predetermined second changing interval and a light intensity of the reflected light is more than the predetermined reference level.

29. The optical disk type determination method according to claim 26, wherein the change of the reflected light is a change of a distribution of a light intensity in a reflected light far field, and
said determining the state of the information recording surface comprises:
determining a region where a push-pull track error signal is effective as a guided groove formed region;
determining a region where a differential phase detection track error signal is effective as a prepit formed region; and
determining a region where a change of a distribution of a reflected light intensity is small and a push-pull track error signal and a differential phase track error signal are not effective as the mirror region.

30. The optical disk type determination method according to claim 26, wherein the optical disk is any of a first optical disk and a second optical disk, the first optical disk has the mirror region whose shape is a ring having a predetermined width is the radial direction and arranged between the management region and the data recording region, and the second optical disk in which the management region and the data recording region is adjacent to each other, and
said determining the type of the optical disk comprises:
determining the optical disk as the first optical disk when the mirror region is detected in the determination region in said determining the state of the information recording surface, and
determining the optical disk as the second optical disk when the mirror region is not detected.

31. The optical disk type determination method according to claim 30, further comprising:
detecting a position of the focused beam along the radial direction,
wherein the first optical disk is any of a third optical disk and a fourth optical disk, wherein the third optical disk has the mirror region in a predetermined position along a radial direction, and the fourth optical disk has the mirror region in an inner circumference side than the predetermined position along the radial direction, and
said determining the type of the optical disk comprises:
determining the optical disk as the third optical disk or the fourth optical disk based on a position of the focused beam when the mirror region is detected in said determining the state of the information recording surface.

32. The optical disk type determination method according to claim 30, further comprising:
detecting an existence or absence of a CAPA header indicating an address of the data recording region,
wherein the first optical disk is any of a third optical disk having the CAPA header and a fourth optical disk not having the CAPA header, and
said determining the type of the optical disk comprises:
determining the optical disk as the third optical disk when the CAPA header is detected in the data recording region in said detecting the existence or absence of the CAPA header, and
determining the optical disk as the fourth optical disk when the CAPA header is not detected in the date recording region in said detecting the existence or absence of the CAPA header.

33. The optical disk device according to claim 17, wherein the control unit is configured to detect an existence or absence of the mirror region in which the track does not exist by measuring a scanning time of the mirror region.

34. The optical disk type determination method according to claim 25, wherein said determining the type of the optical disk comprises
detecting an existence or absence of the mirror region in which the track does not exist by measuring a scanning time of the mirror region.
